(19) United States
(12) Patent Application Publication
(10) Pub. No.: US 2026/0134068 A1
(43) Pub. Date: May 14, 2026

(54) AUTHENTICATION AND SESSION MANAGEMENT USING DEVICE FINGERPRINT

(71) Applicant: PAYPAL, INC., San Jose, CA (US)

(72) Inventors: Sunil Kishor Pathak, Cupertino, CA (US); Elena Chausova, Danville, CA (US); Venkatesan Dasarathan, Fremont, CA (US); Ravikanth Reddy Gudipati, Tracy, CA (US); Rajesh Selvaraj, Fremont, CA (US)

(21) Appl. No.: 18/941,096

(22) Filed: Nov. 8, 2024

(51) Int. Cl. G06F 21/31; H04L 9/40

(52) U.S. Cl. CPC G06F 21/31; H04L 63/0876

(57) ABSTRACT

The disclosed computer-implemented method may include detecting a user authentication request from a user device for a session, determining a confidence score for identifying a device fingerprint of the user device, and authenticating the user device in response to the user authentication request. The authenticating may be based on the confidence score satisfying a confidence threshold. The method may also include identifying other active sessions for other devices associated with the user device, and providing session management for the other active sessions. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an example system for authentication and session management using device fingerprints.

FIG. 2 is a block diagram of an example network for authentication and session management using device fingerprints.

FIG. 3 is an example architecture for authentication and session management using device fingerprints.

FIGS. 4A-E are example workflows for various scenarios of authentication and session management using device fingerprints.

FIG. 5 is an example mapping table for authentication and session management using device fingerprints.

FIG. 6 is a flow diagram of an example method for authentication and session management using device fingerprints.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

User authentication relates to verifying users and/or devices attempting to gain access to a computing resource, such as a user's account with an online service (e.g., a financial account). User authentication often involves identification (e.g., a user proving who they are), authentication (e.g., a user proving they are the user from the identification), and authorization (e.g., a user proving they are allowed to access the computing resource as requested). Several authentication factors are available, such as password-based authentication (e.g., requiring a user to provide a correct password), on-time passwords (OTP) (e.g., requiring a user to provide a code generated for the specific authentication event and may be delivered via a different communication channel), push notification (e.g., requiring a user to respond to a push notification on their mobile device to approve an access request), certificate-based authentication (e.g., requiring a user to provide a digital certificate that may be encrypted), token-based authentication (e.g., requiring a user to provide a unique number that is generated by a user device and a system managing the computing resource), biometric authentication (e.g., requiring a user to provide biometric data), voice authentication (e.g., requiring a user to provide verbal identification), and/or two-factor authentication (2FA) or multifactor authentication (MFA) (e.g., more than one form of authentication).

Although such authentication is important for preventing unauthorized access to the computing resources, the user's overall experience may be diminished. The user may have more than one device and/or use more than one application (e.g., browser, app, etc.) for accessing their computing resources. However, conventional authentication often requires the user to be reauthenticated for each device/application rather than being able to start a session on one device and continue the session on another device. In addition, the user may not easily manage multiple active sessions.

The present disclosure is generally directed to authentication and session management using device fingerprints. As will be explained in greater detail below, embodiments of the present disclosure may determine a device fingerprint of a user device requesting user authentication for a session, and based on a confidence score of the device fingerprint identifying a user account, authenticate the user device and further track the active session. The systems and methods provided herein may track the active sessions of the user account with device fingerprints such that sessions may more readily be continued across the user's devices. By tracking sessions based on device fingerprints, the systems and methods provided herein may improve the functioning of a computer itself by more efficiently manage multiple active sessions, reduce overall network communications required for multiple authorizations/reauthorizations, and provide more flexibility with active sessions. The systems and methods provided herein may further improve the Internet-centric technical field of user authentication over computer networks by using available data signals to reduce a complexity of the authentication process while maintaining protection of computing resources and providing further functionality for authentication multiple devices.

Features from any of the embodiments described herein may be used in combination with one another in accordance with the general principles described herein. These and other embodiments, features, and advantages will be more fully understood upon reading the following detailed description in conjunction with the accompanying drawings and claims.

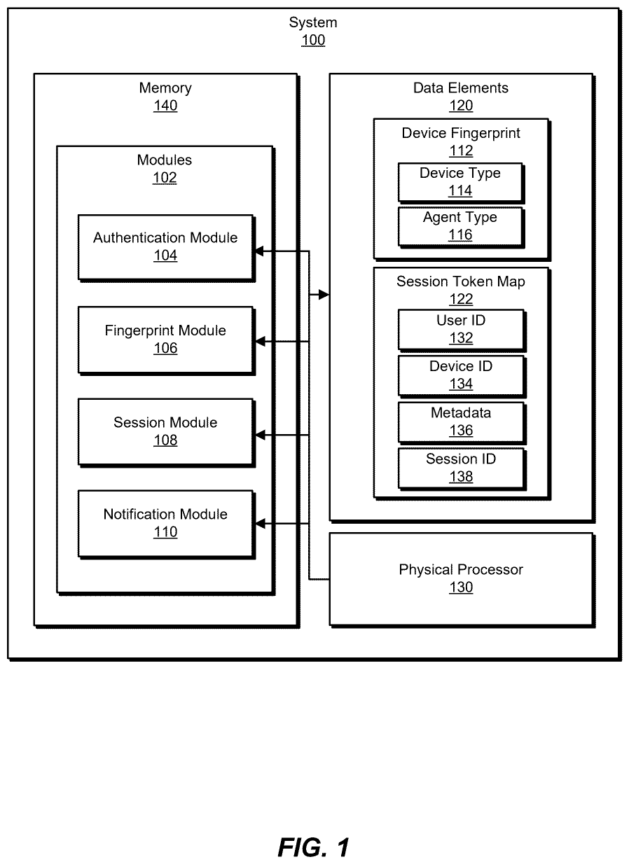

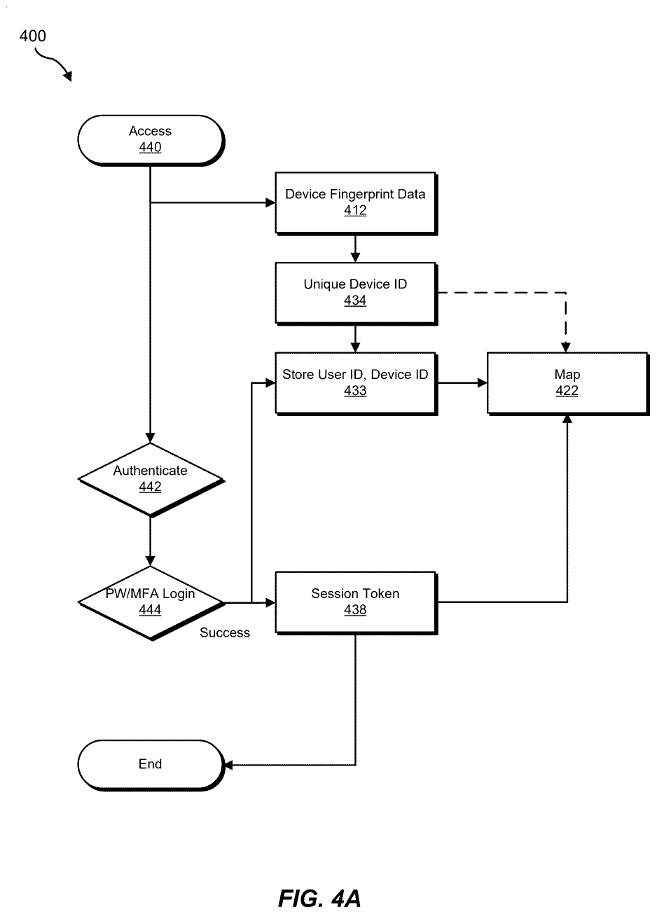

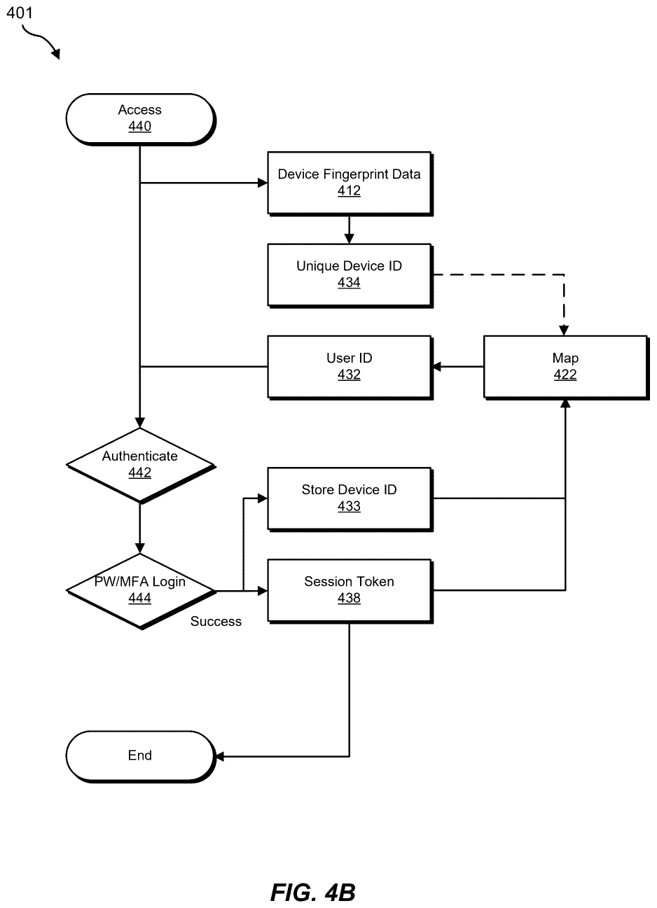

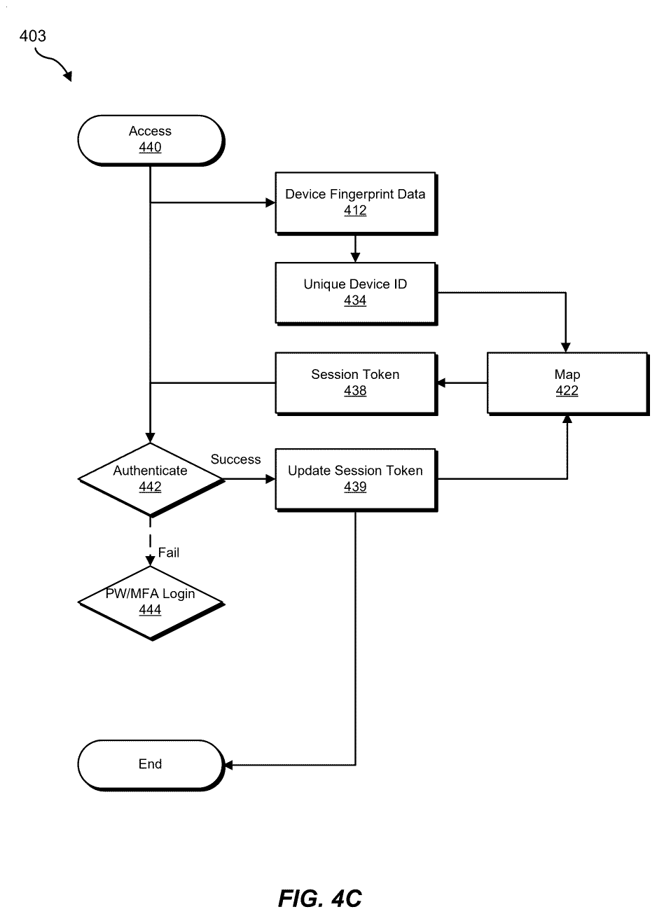

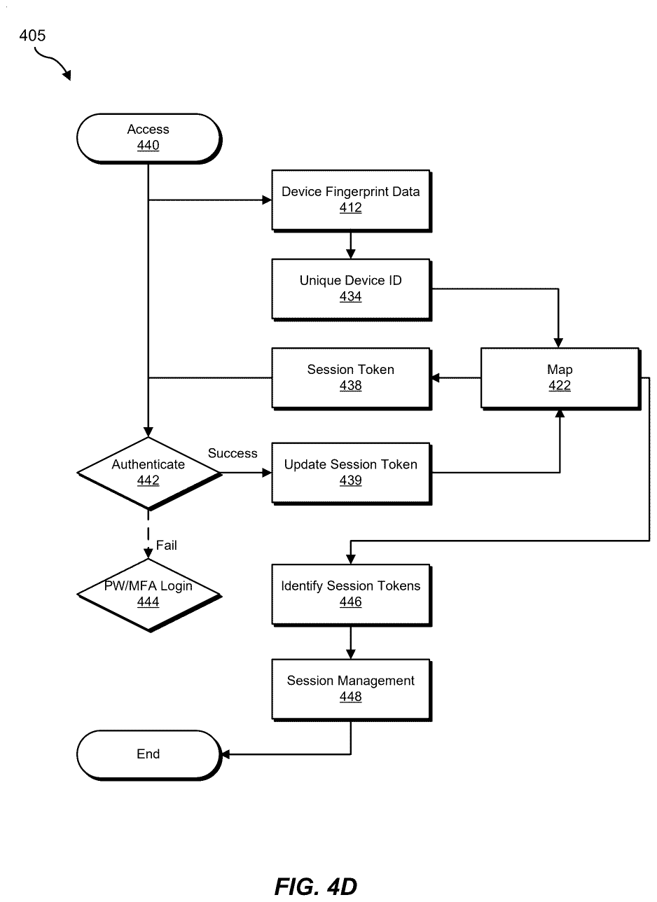

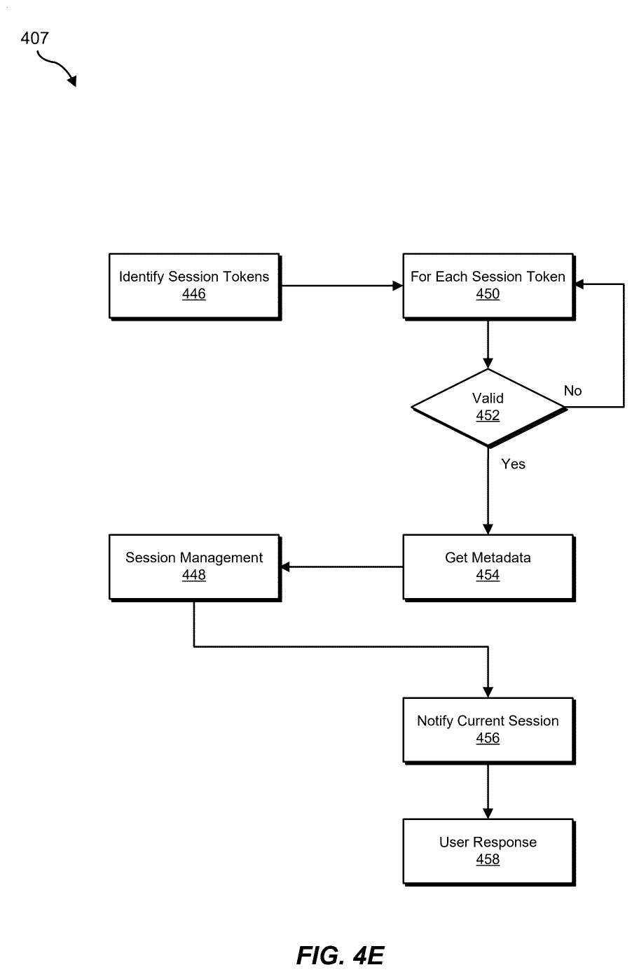

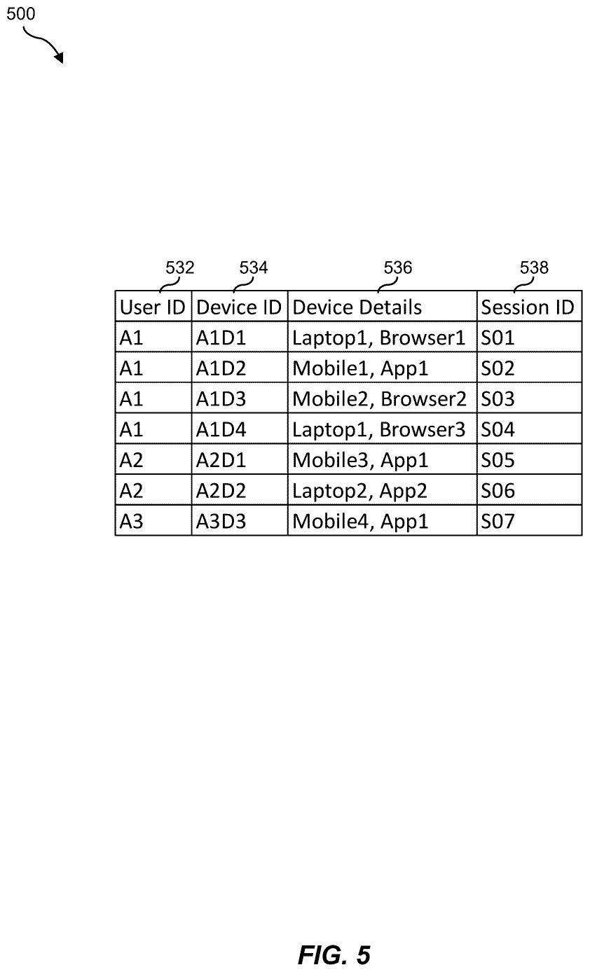

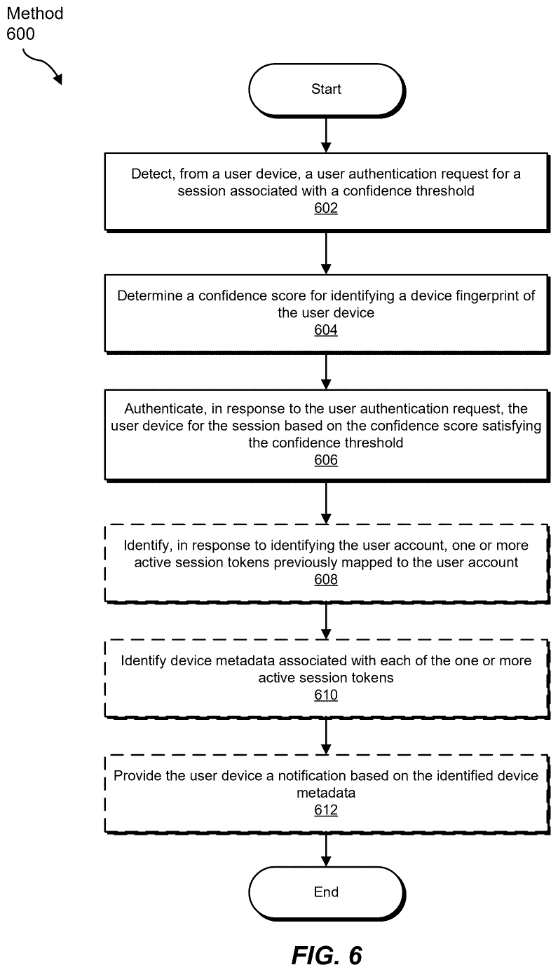

The following will provide, with reference to FIGS. 1-6, detailed descriptions of authentication and session management using device fingerprints. Detailed descriptions of example systems and architectures will be provided in connection with FIGS. 1, 2, and 3. Detailed descriptions of example workflows will be provided in connection with FIGS. 4A-4E. Detailed descriptions of an example mapping scheme will be provided in connection with FIG. 5. In addition, detailed descriptions of related methods will be provided in connection with FIG. 6.

Various systems described herein may perform the processes described herein. FIG. 1 is a block diagram of an example system 100 for authentication and session management using device fingerprints. As illustrated in this figure, example system 100 may include one or more modules 102 for performing one or more tasks. As will be explained in greater detail herein, modules 102 may include an authentication module 104 (for user authentication and related functions), a fingerprint module 106 (for device fingerprint identification and related functions), a session module 108 (for managing sessions and related functions), and a notification module 110 (for further session management and related functions). Although illustrated as separate elements, one or more of modules 102 in FIG. 1 may represent portions of a single module or application.

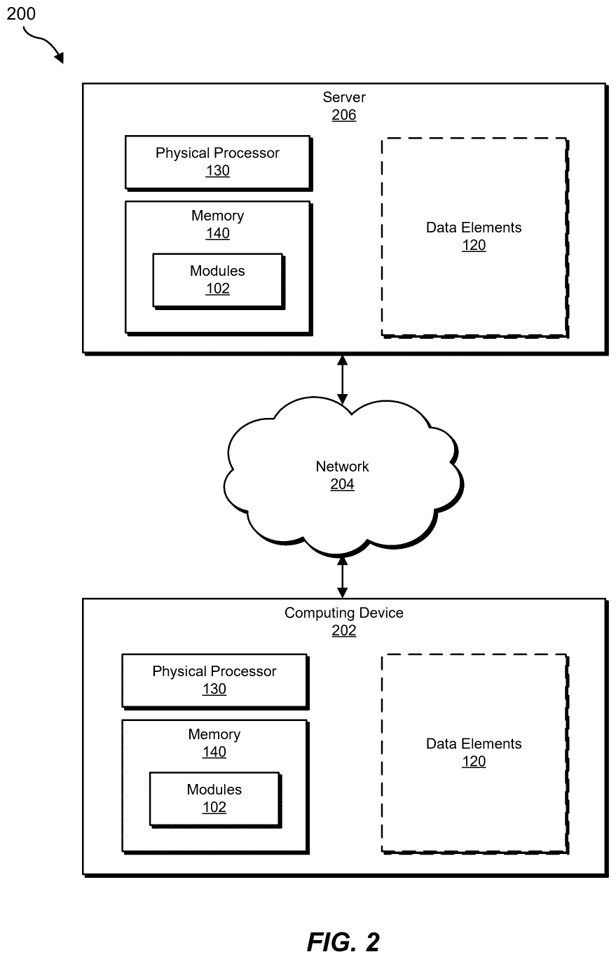

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate authentication and session management using device fingerprints. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more data elements 120, such as device fingerprint 112 and session token map 122. Device fingerprint 112 may include a device type 114 and an agent type 116. Session token map 122 may include a user identifier (ID) 132, a device ID 134, metadata 136, and session ID 138. One or more of data element 120 may be stored on a local storage device, such as memory 140, or may be accessed remotely. Device fingerprint 112 may represent information about software (generally represented by agent type 116) and/or hardware (generally represented by device type 114) of a computing device for identifying the computing device, as will be explained further below. Device type 114 may represent information of a computing device's hardware (e.g., hardware serial numbers such as MAC address, hardware models such as mobile phone model, desktop/laptop model, operating system, screen size/orientation, display aspect ratio, processor/component identification, Internet of Things (IoT) device identification, product names, platform, etc.), as will be explained further below. Agent type 116 may represent information of a computing device's software (e.g., type/version of browser used, browser extensions, browser rendering characteristics, layout engine, language, application programming interfaces (APIs), desktop applications, mobile apps, application/app versions, product names, etc.), as will be explained further below. Further, device type 114 and/or agent type 116 may together represent a user agent (e.g., an identifier of a device's platform/capabilities) such that the examples described herein may not be limited and/or may be delineated differently (e.g., device type 114 may include software information and agent type 116 may include hardware information). In addition, although FIG. 1 illustrates device fingerprint 112 as including device type 114 and agent type 116, in some implementations, device fingerprint 112 may represent device type 114 and/or agent type 116 (e.g., is derived therefrom) rather than directly including such data. Session token map 122 may represent a data structure for tracking user accounts for authentication and session management using device fingerprints, as will be explained further below. User ID 132 may represent a user account (e.g., a unique identifier for a user account), as will be explained further below. Device ID 134 may represent a device fingerprint (e.g., a unique identifier based on device fingerprint 112), as will be explained further below. Metadata 136 may represent device details (e.g., device name, agent name, etc. which in some examples may correspond to device fingerprint information), as will be explained further below. Session ID 138 may represent a unique identifier for a session on a particular device (e.g., a session token or other indicator), as will be explained further below. Moreover, each of data elements 120 may represent one or more instances, such as session token map 122 containing multiple entries of user ID 132, device ID 134, metadata 136, and/or session ID 138.

Example system 100 in FIG. 1 may be implemented in a variety of ways. For example, all or a portion of example system 100 may represent portions of example network environment 200 in FIG. 2.

FIG. 2 illustrates an exemplary network environment 200 implementing aspects of the present disclosure. The network environment 200 includes computing device 202, a network 204, and server 206. Computing device 202 may be a client device or user device, such as a desktop computer, laptop computer, tablet device, smartphone, or other computing device. Computing device 202 may include a physical processor 130, which may be one or more processors, memory 140, which may store data such as one or more of data elements 120, along with other input and/or output devices (e.g., keyboard, mouse, touchscreen, display, etc.) not illustrated in FIG. 2.

Server 206 may represent or include one or more servers capable of authentication and session management using device fingerprints. Server 206 may maintain, for example, mappings of user devices, user accounts, and active sessions, as will be described further below. Server 206 may include a physical processor 130, which may include one or more processors, memory 140, which may store modules 102, and one or more of additional elements 120.

Computing device 202 may be communicatively coupled to server 206 through network 204. Network 204 may represent any type or form of communication network, such as the Internet, and may comprise one or more physical connections, such as LAN, and/or wireless connections, such as WAN.

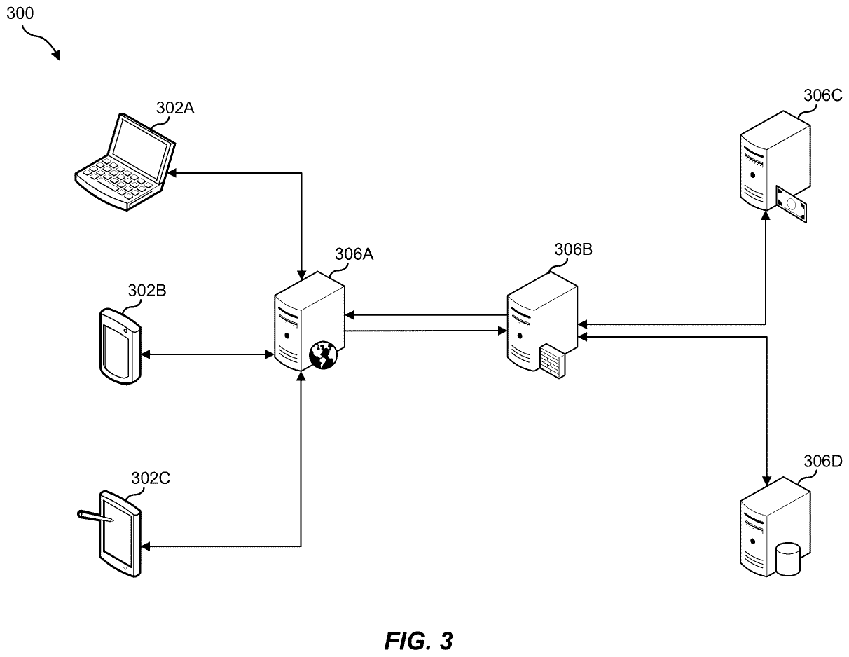

The systems/devices of FIG. 2 may, in some examples, be arranged in an architecture 300 as illustrated in FIG. 3. FIG. 3 includes a user device 302A (e.g., corresponding to a laptop iteration or instance of computing device 202), a user device 302B (e.g., corresponding to a mobile device/smartphone iteration/instance of computing device 202), a user device 302C (e.g., corresponding to a tablet iteration/instance of computing device 202), a web server 306A (e.g., corresponding to an iteration/instance of server 206 configured for hosting a website accessible by user devices), an authentication server 306B (e.g., corresponding to an iteration/instance of server 206 configured for authentication processes), an online service server 306C (e.g., corresponding to an iteration/instance of server 206 configured for hosting an online service such as a payment or other financial service although in other examples may correspond to any other online service or computing resource such that online service server 306C may provide data and/or services to one or more of the computing devices/servers described herein, such as for an app, part of a webpage, etc.), and a database server 306D (e.g., corresponding to an iteration/instance of server 206 configured for hosting a database and/or otherwise managing data). Although illustrated as separate devices, one or more of the devices illustrated in FIG. 3 may represent one or more devices and/or may be integrated (e.g., one or more of web server 306A, authentication server 306B, online service server 306C, and/or database server 306D may be integrated).

In some examples, a user may use multiple user devices, such as user device 302A, user device 302B, and/or user device 302C. The user may access a website (e.g., hosted on web server 306A) that may further reference an online service (e.g., hosted on online service server 306C such that online service server 306C may provide data/services to web server 306A and/or the user devices). For instance, web server 306A may host a merchant website for selling products, which may interface with online service server 306C, that may host a payment service, to allow the user to complete purchases using the payment service (although in other examples web server 306A may host a website for the payment service). The user may visit the website using one or more browsers on user device 302A, may visit the website using a browser or app on user device 302B, and/or may visit the website using a browser or app on user device 302C. For example, the user may visit the website using a first browser (e.g., a desktop browser) on user device 302A, and also visit the website using a second browser (e.g., a different desktop browser as the first browser, the same first browser in a different mode such as mobile mode) on user device 302A or using an application (e.g., a desktop application) on user device 302A. The user may also visit the website using a third browser (e.g., mobile browser) on user device 302B and a mobile application on user device 302B. The user may also visit the website using the mobile application on user device 302C (e.g., which may be configured for user device 302C). The user may switch between these different agent/device combinations, for example start browsing the website on user device 302A using the first browser and continue browsing the website later using the mobile app on user device 302B and/or user device 302C. Web server 306A, authentication server 306B, and/or online service server 306C may consider each of these agent/device combinations as separate, distinct devices (e.g., the first browser with user device 302A being a different device than the second browser with user device 302A, and so forth). In other words, for the purposes of identifying devices (e.g., device fingerprinting) as discussed herein, a server may rely on more than the hardware alone (e.g., a single computing device may be associated with multiple identified devices based on the different browser/applications used).

When the user is ready to purchase products, the user may need to log into their account with the online service (e.g., be authenticated to access the computing resource from online service server 306C). As described above, a conventional authorization scheme may require the user to log in (e.g., be authenticated) on each device. Accordingly, the user may log in using user device 302A, but when later browsing with user device 302B (and/or user device 302C), will need to log in again with the other device. In addition to the degraded and fragmented user experience of having to log in multiple times (e.g., when switching devices, switching browsers/apps on a device, etc.), which may be time-consuming and lead to potential abandonment of services, the multiple log in may lead to increased security risk, as the user may become more at risk for security breaches (e.g., having certain devices being more susceptible to security breaches, being more likely to be exposed to phishing attacks or other credential thefts, disabling 2FA or MFA due to having to log in multiple times, potential errors from authentication of multiple devices, etc.). Further, as multiple active sessions may be authenticated, the user may not be aware of or otherwise may not easily manage the multiple sessions, presenting potential security risks (e.g., unauthorized users gaining access to the physical device, being unaware of an authorized active session, other potential security loopholes).

As will be described further below, device fingerprinting may be used to improve the authentication process. Device fingerprinting may allow fully or partially identifying an individual device using collected information about the hardware and/or software of the device without requiring, for example, cookies or other persistent data on the device. Various signals, such as browser information (e.g., type of browser, browser version, user agents, plugins or fonts installed, etc.), system configuration (e.g., screen resolution, battery information, operating system, time zone settings, language settings, machine brand/model, etc.), and/or network information (e.g., HTTP request headers, IP addresses, etc.) may be used to generate (e.g., using a fingerprinting algorithm such as a hashing function) a unique identifier (device fingerprint) for the device. As changes to such signals may generate a different identifier, analyzing a given device fingerprint to determine similarity to known device fingerprints of a particular device may produce a confidence score of whether the given device is the same as the particular device.

FIGS. 4A-4E illustrate various example workflow scenarios of authentication and session management using device fingerprints with further reference to FIG. 3. FIG. 4A illustrates a workflow 400 corresponding to an initial login attempt with a first device. At 440, a user device such as user device 302A, user device 302B, and/or user device 302C may attempt accessing a computing resource. For example, the user device may be attempting to user a payment service provided by online service server 306C (which may be direct or indirect such as through web server 306A, which may include actively attempting to log in (e.g., directly accessing a log in interface) or passively attempting to log in (e.g., initiating a session in order to use a feature provided by the service). Accordingly, the device may need to be authenticated (e.g., identify/validate the user device) at 442 by authentication server 306B.

However, as the user device attempts the access, the user device may send, at 412, device fingerprint data (e.g., device type 114, agent type 116, and/or other information as described herein). For example, the user device, when accessing web server 306A (e.g., accessing, using a browser/application, a website hosted on web server 306A which may in turn access, such as through a widget on the website, online service server 306C for the computing resource, although in other examples, the user device may additionally and/or alternatively access online service server 306C such as through a website via a browser and/or an application/app), may provide the data relevant to device fingerprinting, which may be forwarded (e.g., from web server 306A and/or online service server 306C) to an authentication server or other appropriate server for session management (e.g., authentication server 306B) as needed. The authentication server may, at 434, determine a device fingerprint (e.g., device fingerprint 112) for the user device, identify a corresponding user account, and generate a unique device ID (e.g., device ID 134) for associating with the user account.

In some examples, the authentication server may determine a confidence score of the device fingerprint matching a user account (which in some examples may be retrieved from online service server 306C and/or database server 306D). The type of access attempted at 440 may dictate a confidence score threshold. For example, if the type of action corresponds to a higher security/higher risk action (e.g., an action that may cause a transfer of funds, change user identity, etc.) the confidence score threshold may be higher (e.g., 99% on a 0-100% scale, 0.99 on a 0-1 scale, etc.). Actions corresponding to lower security/lower risk actions (e.g., viewing an account, viewing options, re-authenticating a previously authenticated device, etc.) may have a corresponding lower confidence score threshold (e.g., 90%, etc.). Moreover, the confidence score threshold may generally represent or correspond to a security risk, such that higher confidence score thresholds may also indicate higher authentication standards (e.g., an increased number of authentication factors needed). If the device fingerprinting fails to satisfy the appropriate confidence score threshold to identify the user device, the device fingerprint-based authentication at 442 may fail, proceeding to a full login requirement at 444, as will be described further below.

In some implementations, if the user device is sufficiently identified (e.g., based on satisfying the confidence score threshold for the access attempt), the authentication server may generate the device ID. The device ID may incorporate some of the information used for device fingerprinting, such as concatenating certain features, although in other examples, the device ID may be the device fingerprint itself and/or a variation thereof.

The authentication server may, at 422, refer to a map (e.g., session token map 122) to determine whether the device ID is associated with a particular user account. The map may track active sessions for user accounts on each of their associated (and previously identified) devices. FIG. 5 illustrates an example table 500 corresponding to session token map 122. Table 500 includes user ID 532 (corresponding to user ID 132), device ID 534 (corresponding to device ID 134), device details 536 (corresponding to metadata 136), and session ID 538 (corresponding to session ID 138). In other examples, other information may also be stored.

Returning to FIG. 4A, the example illustrated in FIG. 4A may correspond to an initial access attempt by the user, such that the user (e.g., user account, user devices, etc.) may not be found in table 500. Accordingly, the device fingerprint-based authentication at 442 may fail, proceeding to a full login requirement at 444.

At 444, the authentication server may request a full login, which may correspond to requesting a password (and user ID), and/or other authentication factors (e.g., 2FA, MFA, and/or any other authentication factor described herein). Once the user, via the user device, successfully completes the login, the authentication server may establish a session token at 438. The session token may correspond to information about the user and/or device (e.g., user ID 132, device ID 134, metadata 136, and/or session ID 138, and in some implementations device type 114, agent type 116, and/or device fingerprint 112) that may be stored on the server (e.g., web server 306A, authentication server 306B, and/or online service server 306C) to indicate that the device (e.g., communications therewith) may be trusted, for as long as the session token is valid, and may be uniquely identified (e.g., by session ID 138). The user device may also store its own version of the session token (e.g., session ID 138) in some examples, although in the examples described herein, the user device may instead provide device fingerprint data in lieu of or in addition to a session token, which the user device may send with requests to the server. The server may see the session token provided by the user device, and/or identify the user device as satisfying an appropriate confidence score threshold from the device fingerprint, and accordingly send requested data (e.g., webpages and/or more generally provide access to the requested computing resource).

To allow the device fingerprinting-based authentication, the authentication server may track this authentication. For example, the authentication server may, at 433, store the corresponding user ID and device ID along with the session token (from 438) in the map. Thus, in FIG. 5, table 500 may include an appropriate entry. For example, the first entry in table 500 refers to a user account with user ID of “A1,” a device ID of “A1D1” (which may be used to distinguish between different devices associated with user “A1” as determined from device fingerprints, although in some examples, the device ID may further be globally unique to all device IDs in table 500), with device details describing the user device (e.g., “Laptop 1, Browser1” indicating that device “A1D1” is a laptop that accessed the server via a browser, although in other examples more specific details may be stored) that in some examples may be generated from the device fingerprint data, and a session ID of “S01” (which may be unique to all the sessions associated with user ID “A1” and/or device ID “A1D1” although in some implementations may be globally unique to all session IDs in table 500). In some implementations, table 500 may include additional data, such as session expiration information (e.g., a time to expire, an expiration time, a last accessed time, a valid flag, etc.) which in some implementations may be integrated with other data (e.g., session IDs incorporating session expiration information). In yet further examples, a session may not necessarily expire (e.g., having a long time to expire, or expiring upon a user logout).

FIG. 4B illustrates a workflow 401 corresponding to a login attempt with a second device. Similarly numbered steps as in FIG. 4A may correspond to similar steps, with variations described further below. FIG. 4B may correspond to a second device differing from that of FIG. 4A, for example corresponding to a different user device (e.g., another of user device 302A, user device 302B, and/or user device 302C) and/or another user agent (e.g., the same device but with a different browser/app, a different device with a similar browser/app, a different device with a different browser/app, etc.). In addition, FIG. 4B may correspond to an example of access 440 after one or more iterations of workflow 400 in FIG. 4A.

In FIG. 4B, access 440 may be associated with its own appropriate confidence score threshold. The device fingerprint data provided to the authentication at 412 may generate, at 434, a unique device ID that may not be found in the map at 422 (or may be associated with an expired session), such that the authentication at 442 may fail, requiring a full login at 444. However, the device fingerprinting may satisfy identifying a user ID at 432. In some examples, the user ID may be provided at for the full login at 444, such that the login may not require the user ID, and/or a reduce number of authentication factors may be requested (e.g., based on the type of access requested, similar to the confidence score threshold).

After the user successfully logs in at 444 (e.g., satisfying the requested authentication factors) the authentication server may, at 433, associate the device ID with the user ID in the map, and further at 438 also associate the session token for the current authenticated session. For example, in FIG. 5, the second entry may refer to user “A1” having logged in with device “A1D2” that may correspond to “Mobile1, App1” and have a valid session “S02.”

Turning now to FIG. 4C, FIG. 4C illustrates a workflow 403 corresponding to a subsequent login attempt with a device. Similarly numbered steps as in FIG. 4A and/or FIG. 4B may correspond to similar steps, with variations described further below. FIG. 4C may correspond to the user logging in with a device that has already logged in (e.g., in FIG. 4A and/or FIG. 4B). In other words, the user may be attempting access 440 with the same device and/or agent that the user previously successfully logged in with.

In FIG. 4C, access 440 may be associated with its own appropriate confidence score threshold. In contrast to FIG. 4B, in FIG. 4C, the device fingerprint data provided in 412 may satisfy the confidence score threshold (otherwise failing the authentication at 442 and requiring a full login at 444) such that the authentication server may generate a device ID at 443 that may be found in the map at 422. For example, referring to FIG. 5, the device fingerprint may indicate a device already mapped to a valid session (e.g., “A1D1” with “S01” and so forth). Accordingly, at 438, the authentication server may find the valid session token (which may be indicated as valid such as by the session ID and/or session expiration information as described herein) such that the device fingerprint-based authentication at 442 is successful. In some implementations, the authentication server may, at 439, update the session token (e.g., in the map) such as by extending the session expiration time.

Turning now to FIG. 4D, FIG. 4D illustrates a workflow 405 corresponding to a login attempt with session management. Similarly numbered steps as in FIG. 4A, FIG. 4B, and/or FIG. 4C may correspond to similar steps, with variations described further below. FIG. 4D may be similar to FIG. 4C in that the user may be attempting access 440 with the same device and/or agent that the user previously successfully logged in with. However, in FIG. 4D, after updating the session token at 439, the authentication server may check the map for other valid sessions associated with the user ID. For example, referring to FIG. 5, for the user “A1,” the valid sessions may include “S01,” “S02,” “S03,” and “S04.” Alternatively, for the user “A2,” the valid sessions may include “S05” and “S06.”

The authentication server may, at 446, identify the active session tokens, to provide session management at 448. Session management may include, for example, pruning active sessions (e.g., limiting a number of total active sessions which may be a configurable number and/or a dynamic number based on user activity) which may include deactivating or otherwise invalidating sessions (e.g., selected based on oldest, least active, lowest confidence scores, other risk factors associated with device details, etc.), modifying, altering, or otherwise updating the sessions (e.g., dynamically adjusting associated confidence score thresholds, such as raising thresholds for older sessions), and other automatic session management.

In yet other implementations, the authentication server may provide the user with manual session management. For example, the authentication server may provide a notification to the user regarding active sessions on the other devices (e.g., devices other than the current user device of attempting access 440). The authentication server may provide details of the other active sessions based on the metadata (e.g., informing user “A1” that there is an active session on a particular mobile device and browser, etc., informing user “A2” that there are no other active sessions and/or foregoing manual session management due to a lack of other active sessions) and/or other data associated with each active/valid session (e.g., last accessed, last action taken, etc.). Further, in some examples, the user may be able to provide a response, such as providing a selection of active session to deactivate, keep active, etc.

FIG. 4E illustrates a workflow 407 corresponding to an example of session management, and in some implementations represents substeps of steps 446 and 448 in FIG. 4D. As illustrated in FIG. 4E, identifying session tokens (e.g., 446) for the current user may include evaluating each related session token at 450. The authentication server may, as it iterates through the session tokens, determine, at 452, whether a currently evaluated session token is valid (e.g., checking its validity as described above, such as determining if a session expiration time has elapsed, whether there is additional metadata/flag indicating validity/invalidity, whether there is an error associated with the session token, etc.). If the currently evaluated session token is not valid, the authentication server may return to 450 for the next iteration. Although in some examples the authentication server may remove entries for invalid sessions, in some implementations, retaining such entries may ensure that every device that the user has used is mapped to the user.

If the session token is valid, then at 454 the authentication server may retrieve the associated metadata (e.g., metadata 136), which may include details such as device name (e.g., device type 114 and/or device ID 134), agent name (e.g., agent type 116 and/or device ID 134) and/or other session information. In some implementations, the metadata may include session state information, such as a state of the user's actions for that particular state (e.g., performing a payment, performing a checkout for purchasing a product, other states of accessing a computing resource, etc.). For instance, the metadata may include information to inform the user of specific session details. Further, in some implementations, the metadata may include information to allow the user to resume one or more of the sessions. For example, the metadata may include data that the user has filled in (which in some examples may be encrypted, and/or alternatively the metadata may include a pointer to where the data is stored).

With the collected metadata of each valid session token, the authentication server may perform session management at 448, as described above. More specifically, the authentication server may, at 456, notify the current session (e.g., the session triggering the current workflow) by providing the metadata to the current user device. In some examples, the authentication server may format the metadata in a user-readable format to be presented on the user device. At 458, the authentication server may receive a user response (e.g., one or more communications from the user device), which may include a selection of which active sessions to end and/or which active sessions to continue. For instance, the user response may indicate which sessions to end, which the authentication server may accordingly invalidate the session tokens as indicated. In addition and/or alternatively, the user response may indicate which active sessions to continue. For instance, the user may wish to pick up a prior session (e.g., if in the middle of a checkout, etc.), which the metadata may include data to allow the user device to restore the prior session (e.g., filling out a web form with the data, proceeding to a particular step/page in the process, etc.). Moreover, in some examples, the session management may also include combining and/or updating sessions (e.g., for sessions corresponding to a same action, updating sessions to a same most recent state, combining states such as piecing together partially completed forms, cancelling older sessions from the action, etc.).

Referring back to FIG. 5, in one example, for user “A1,” the authentication server may iterate through every entry in table 500 for the user (e.g., at 450). For example, the user “A1” may have previously accessed the service using a first laptop and a first browser (e.g., session “S01”), pausing that session and using a first mobile device and a first app (e.g., session “S02”), later using a second mobile device and a second browser (e.g., session “S03”), and now using the first laptop and a third browser (e.g., session “S04” which may correspond to a current session). In other words, user “A1” may have used different devices as well as different applications, either with the same device or across different devices. The authentication server may confirm whether each session is valid (e.g., at 452), and accordingly retrieve the metadata for the valid sessions.

The authentication server may then notify the user of the other active sessions (e.g., at 456). For example, the authentication server may provide a notification to the user device summarizing each session to allow the user to recognize the devices. Assuming for this example all the entries are valid, the notification may include messages such as “You have an active session on this device with Browser1,” (for “S01” on the same user device but different browser), “You have an active session on Mobile1 with App1,” (for “S02” on the first mobile device using the first app), and “You have an active session on Mobile2 with Browser2” (for “S03” on the second mobile device with the second browser). In some examples, the notification may include additional session state information, for example for “S01,” “You were checking out at [merchant] on this device with Browser1” (e.g., if user “A1” was in the middle of checking out before pausing session “S01”). As described herein, user “A1” may respond (from the current user device, e.g., “A1D4”) with instructions to close/end selected sessions, or to continue with one or more sessions (e.g., merging session states).

In a second example in FIG. 5 for user “A2,” the authentication server may see “S05” and “S06” (e.g., at 450). Assuming “S06” refers to the current session, and assuming for this example that “S05” is not a valid session (e.g., at 452), the authentication server may not need to notify user “A2” of other active sessions (e.g., skipping 454 and 448 that may include 456 and 458). In a third example, for user “A3,” assuming for this example that session “S07” is the current session, the authentication server may not see other entries for user “A3,” (e.g., skipping 450 and steps thereafter for session management).

FIG. 6 is a flow diagram of an exemplary computer-implemented method 600 for authentication and session management using device fingerprints. The steps shown in FIG. 6 may be performed by any suitable computer-executable code and/or computing system, including the system(s) illustrated in FIGS. 1, 2 and/or 3. In one example, each of the steps shown in FIG. 6 may represent an algorithm whose structure includes and/or is represented by multiple sub-steps, examples of which will be provided in greater detail below. Further, method 600 may correspond to or otherwise represent the flows illustrated in FIGS. 4A-4E described above.

As illustrated in FIG. 6, at step 602 one or more of the systems described herein may detect, from a user device, a user authentication request for a session associated with a confidence threshold. For example, authentication module 104 (e.g., of an authentication server such as server 206) may detect a user authentication request (e.g., from a user device such as computing device 202).

The systems described herein may perform step 602 in a variety of ways. In one example, the user authentication request corresponds to a user action and the confidence threshold is based on an authentication strength associated with the user action. As described above with respect to FIGS. 4A-4E, the confidence threshold may represent a security requirement associated with the attempted user action, which may be static (e.g., previously configured for each type of action) and/or dynamic (e.g., changing based on analyzing historical behaviors associated with the attempted action). For instance, user actions such as viewing an account may be associated with a lower security risk (and accordingly lower confidence threshold) than other user actions such as modifying an account, transferring funds, etc., although in some implementations the associated security risk (and confidence threshold) may be updated over time (e.g., by identifying changes in security risks). In addition, as described above, other risk factors may affect or otherwise modify the confidence threshold. For instance, accounts that have been idle or previously subjected to fraud/hacking may be associated with a higher security risk (and accordingly higher confidence threshold).

At step 604 one or more of the systems described herein may determine a confidence score for identifying a user account from a device fingerprint of the user device. For example, fingerprint module 106 may generate device fingerprint 112 (using, for example, device type 114 and agent type 116 provided by the user device) along with a corresponding confidence score (e.g., of matching a previously identified device).

The systems described herein may perform step 604 in a variety of ways. In some implementations, the server may dynamically adjust the confidence threshold and/or otherwise apply multiple confidence thresholds. For example, the server may apply an initial confidence threshold to sufficiently identify the device and/or user (as described above), and server may analyze the action, device and/or user for potential risk factors and accordingly apply a second (e.g., higher) confidence threshold (e.g., to the same confidence score).

As illustrated in FIG. 6, at step 606 one or more of the systems described herein may authenticate, in response to the user authentication request, the user account on the user device for the session based on the confidence score satisfying the confidence threshold. For example, authentication module 104 may compare the confidence score to the (one or more) confidence threshold.

The systems described herein may perform step 606 in a variety of ways. In one example, authenticating the user device may include determining a device identifier derived from the device fingerprint (e.g., device ID 134 based on device fingerprint 112), identifying the user account associated with the device fingerprint in response to the confidence score satisfying the confidence threshold (e.g., by finding the device ID 134 in session token map 122, and finding the corresponding user ID 132), mapping a session token to the user account and the device identifier (e.g., by creating/updating an entry in session token map 122 that links user ID 132, device ID 134, session ID 138, and/or metadata 136), and authenticating the user device for the session using the session token (e.g., updating session token map 122 to indicate that session ID 138 is valid/active).

In some examples, mapping the session token may further include creating a new session token (e.g., a new session ID 138) as the session token for the session, and mapping the new session token to the user account and the device identifier. In some examples, mapping the session token may further include identifying a prior session token previously mapped to the user account and the device identifier (e.g., session ID 138 already in session token map 122), and updating the prior session token as the session token.

In addition, in some examples, the mapping may further include mapping device metadata (e.g., metadata 136) derived from the device fingerprint (e.g., device fingerprint 11, device type 114, and/or agent type 116). In some examples, the device metadata may include a type of device (device type 114) and/or a type of agent (agent type 116) derived from the device fingerprint (e.g., extracted from device fingerprint 112 or otherwise passed along as data). Further, in some examples, the device identifier may be unique for each combination of the type of device and the type of agent.

In some examples, method 600 may generally refer to a previously identified user device logging in with device fingerprint-based authentication (see, e.g., FIG. 4C). In some examples, method 600 may further include providing user notifications for session management. For example, optionally at step 608, session module 108 and/or notification module 108 may identify, in response to identifying the user account, one or more active session tokens previously mapped to the user account (e.g., other entries in session token map 122 for user ID 132, device ID 134, metadata 136, and session ID 138). Optionally, at step 610, session module 108 and/or notification module 108 may identify the device metadata associated with each of the one or more active session tokens (e.g., metadata 136). Optionally, at step 612, notification module 108 may provide the user device a notification based on the identified device metadata. For example, (as also described above with respect to FIGS. 4D and 4E), notification module 110 may review every entry in session token map 122 corresponding to the user (e.g., user ID 132) and provide corresponding metadata 136 for each session identified as active.

In some examples, method 600 may further include receiving, from the user device in response to the notification, an update request for the one or more active session tokens, and updating, in response to the update request, the one or more active session tokens (e.g., session module 108 and/or notification module 110 may receive the update request and accordingly update session token map 122). In some examples, the update request may correspond to a deactivation request such that the indicated active session tokens may be deactivated. In other examples, the update request may correspond to updating the indicated active session tokens to a more current state. In yet other examples, the update request may correspond to resuming/restoring a current session based on the indicated active session tokens, such that session state data may further be retrieved based on the indicated active session tokens and/or updating/merging such data as needed.

Moreover, if one or more of steps 602, 604, and/or 606 fail, method 600 may further include prompting, for the user authentication request in response to failing to satisfy the confidence threshold, one or more authentication factors (e.g., authentication module 104 may request the user device additional authentication as also described above with respect to FIGS. 4A-4B), and authenticating the user device based on the one or more authentication factors.

As detailed above, the systems and methods provided herein improve authentication and session management to address the inconvenience and security vulnerability associated with repeated user authentication across multiple browsers and devices. The systems and methods provided herein may leverage mapping user devices with their account number.

For example, when the user logs in, a session token (e.g., session ID 138), id_token (e.g., user ID 132 and/or device ID 134), etc. are generated and saved on the user's machine (client). With every call from the client to the server, session token, id_token, and/or other token relevant to authenticate the user session is passed from the client to the server. The server may recognize these tokens such that the server may not request a login. This validation (e.g., whether to ask for credential or not), may be decided by an identity system or other authentication system/server.

When the user accesses the login/checkout page, user device ID may be passed along. When the user logs in successfully, and at the time of session token, id_token, relevant token creation, those tokens may be mapped with deviceID.

One example workflow may include: retrieving all the deviceIDs mapped to this user, and for all the deviceIDs, creating a map to all required token(s) which are needed to avoid re-login. Accordingly, when the user tries to login/checkout from another browser or other machine, again deviceID may be passed to the login, and similarly other device's deviceID will be passed to login page.

In another aspect, the workflow may include: retrieving the token mapped to for this device and determining whether it is sufficient to authenticate user. If yes, the login step may be skipped. In some examples, the confidence score may define how confidently this device can be vouched for the given account number and may vary from 0-100%.

There may be different tasks for which user needs to log in. Some tasks may require more authentication (e.g., transferring an account balance to a bank account, sending money to someone, etc.), whereas some may require less authentication (e.g., checking balance). Based on the above severity of tasks and value of confidence score, additional authentication methods may be used (e.g., passkey, thumb print, etc.).

The systems and methods provided herein further address session management/notification, for instance by creating a new mapping of userID with a list of sessionIDs, deviceID, deviceDetails (e.g., type of device, type of browser, etc.). In an example workflow, when a new sessionID is generated for a given userID, the process may include retrieving the list of all sessionIDs, deviceDetails, and for each active sessionID, retrieving the device account_details (type of device, type of browser), and notifying the user with device name and type of browser where they have an active session (e.g.,. a purchase pending, etc.).

In some aspects, the techniques described herein relate to a system including: a processor; and a non-transitory computer-readable medium having stored thereon instructions that are executable by the processor to cause the system to perform operations including: receiving, from a first application on a first user device, a first session request for an online interaction with an online service; identifying the first user device from the first session request based at least on the first application and a first device type of the first user device; authenticating a user account for the first session request using one or more authentication factors; establishing, in response to authenticating the first session request, a first active session for the user account on the first user device; associating the active session with the user account and the first user device using the identified first application and the identified first device type; receiving, from a second application on a second user device, a second session request for the online interaction with the online service; identifying the second user device from the second session request based at least on the second application and a second device type of the second user device; determining a confidence score that the second user device identified from the second session request matches the user account based on the first user device associated with the user account; authenticating the user account for the second session request based on the confidence score satisfying a confidence threshold associated with the online interaction; and establishing, in response to authenticating the second session request, a second active session for the user account on the second user device.

In some aspects, the techniques described herein relate to a system, wherein associating the active session with the user account and the first user device further includes storing a session identifier for the active session with a user account identifier for the user account, and a first user device identifier for the first user device based on the identified first application and the identified first device type.

In some aspects, the techniques described herein relate to a system, wherein the instructions further cause the system to perform operations including: identifying one or more user devices associated with the user account; detecting the one or more active sessions based on the identified one or more user devices; and providing a notification of the one or more active sessions.

In some aspects, the techniques described herein relate to a system, wherein the instructions further cause the system to perform operations including: receiving, from the user device, a selection of the one or more active sessions; and deactivating the selected one or more active sessions.

In some aspects, the techniques described herein relate to a system, wherein the confidence threshold corresponds to a desired security associated with the online interaction using the online service.

In some aspects, the techniques described herein relate to a non-transitory computer-readable medium having stored thereon instructions that are executable by a processor of a computing system to cause the computing system to perform operations including: determining a login attempt by a user device; creating a device fingerprint for the user device; finding a user account that satisfies a confidence threshold for matching with the device fingerprint; and completing the login attempt on the user device for the user account based on satisfying the confidence threshold.

In some aspects, the techniques described herein relate to a non-transitory computer-readable medium, wherein the login attempt corresponds to a passive login attempt based on an inactive session.

In some aspects, the techniques described herein relate to a non-transitory computer-readable medium, wherein the instructions further cause the computing system to perform operations including: requesting, in response to failing to satisfy the confidence threshold, a user login with one or more login credentials; and completing the login attempt using the one or more login credentials.

In some aspects, the techniques described herein relate to a non-transitory computer-readable medium, wherein the instructions further cause the computing system to perform operations including: tracking the completed login attempt with the user account and the device fingerprint; detecting a second login attempt by a second user device; creating a second device fingerprint for the second user device; finding the user account that satisfies a second confidence threshold for matching with the second device fingerprint; and completing the second login attempt on the second user device for the user account based on satisfying the confidence threshold.

In some aspects, the techniques described herein relate to a computer-implemented method including: detecting, from a user device, a user authentication request for a session associated with a confidence threshold; determining a confidence score for identifying a user account from a device fingerprint of the user device; and authenticating, in response to the user authentication request, the user account on the user device for the session based on the confidence score satisfying the confidence threshold.

In some aspects, the techniques described herein relate to a computer-implemented method, wherein authenticating the user device further includes: determining a device identifier derived from the device fingerprint; identifying the user account associated with the device identifier in response to the confidence score satisfying the confidence threshold; mapping a session token to the user account and the device identifier; and authenticating the user device for the session using the session token.

In some aspects, the techniques described herein relate to a computer-implemented method, wherein mapping the session token further includes: creating a new session token as the session token for the session; and mapping the new session token to the user account and the device identifier.

In some aspects, the techniques described herein relate to a computer-implemented method, wherein mapping the session token further includes: identifying a prior session token previously mapped to the user account and the device identifier; and updating the prior session token as the session token.

In some aspects, the techniques described herein relate to a computer-implemented method, wherein the mapping further includes mapping device metadata derived from the device fingerprint.

In some aspects, the techniques described herein relate to a computer-implemented method, wherein the device metadata includes a type of device and a type of agent derived from the device fingerprint.

In some aspects, the techniques described herein relate to a computer-implemented method, wherein the device identifier is unique for each combination of the type of device and the type of agent.

In some aspects, the techniques described herein relate to a computer-implemented method, further including: identifying, in response to identifying the user account, one or more active session tokens previously mapped to the user account; identifying the device metadata associated with each of the one or more active session tokens; and providing the user device a notification based on the identified device metadata.

In some aspects, the techniques described herein relate to a computer-implemented method, further including: receiving, from the user device in response to the notification, an update request for the one or more active session tokens; and updating, in response to the update request, the one or more active session tokens.

In some aspects, the techniques described herein relate to a computer-implemented method, further including: prompting, for the user authentication request in response to failing to satisfy the confidence threshold, one or more authentication factors; and authenticating the user device based on the one or more authentication factors.

In some aspects, the techniques described herein relate to a computer-implemented method, wherein the user authentication request corresponds to a user action and the confidence threshold is based on an authentication strength associated with the user action.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive device data to be transformed, transform the device data, output a result of the transformation to perform device fingerprinting, use the result of the transformation to identify a user account, and store the result of the transformation to authenticate the device and establish a session. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
receiving, from a first application on a first user device, a first session request for an online interaction with an online service;
identifying the first user device from the first session request based at least on the first application and a first device type of the first user device;
authenticating a user account for the first session request using one or more authentication factors;
establishing, in response to authenticating the first session request, a first active session for the user account on the first user device;
associating the active session with the user account and the first user device using the identified first application and the identified first device type;
receiving, from a second application on a second user device, a second session request for the online interaction with the online service;
identifying the second user device from the second session request based at least on the second application and a second device type of the second user device;
determining a confidence score that the second user device identified from the second session request matches the user account based on the first user device associated with the user account;
authenticating the user account for the second session request based on the confidence score satisfying a confidence threshold associated with the online interaction; and
establishing, in response to authenticating the second session request, a second active session for the user account on the second user device.

2. The system of claim 1, wherein associating the active session with the user account and the first user device further comprises storing a session identifier for the active session with a user account identifier for the user account, and a first user device identifier for the first user device based on the identified first application and the identified first device type.

3. The system of claim 1, wherein the instructions further cause the system to perform operations comprising:
identifying one or more user devices associated with the user account;
detecting the one or more active sessions based on the identified one or more user devices; and
providing a notification of the one or more active sessions.

4. The system of claim 3, wherein the instructions further cause the system to perform operations comprising:
receiving, from the user device, a selection of the one or more active sessions; and
deactivating the selected one or more active sessions.

5. The system of claim 1, wherein the confidence threshold corresponds to a desired security associated with the online interaction using the online service.

6. A non-transitory computer-readable medium having stored thereon instructions that are executable by a processor of a computing system to cause the computing system to perform operations comprising:
determining a login attempt by a user device;
creating a device fingerprint for the user device;
finding a user account that satisfies a confidence threshold for matching with the device fingerprint; and
completing the login attempt on the user device for the user account based on satisfying the confidence threshold.

7. The non-transitory computer-readable medium of claim 6, wherein the login attempt corresponds to a passive login attempt based on an inactive session.

8. The non-transitory computer-readable medium of claim 6, wherein the instructions further cause the computing system to perform operations comprising:
requesting, in response to failing to satisfy the confidence threshold, a user login with one or more login credentials; and
completing the login attempt using the one or more login credentials.

9. The non-transitory computer-readable medium of claim 6, wherein the instructions further cause the computing system to perform operations comprising:
tracking the completed login attempt with the user account and the device fingerprint;
detecting a second login attempt by a second user device;
creating a second device fingerprint for the second user device;
finding the user account that satisfies a second confidence threshold for matching with the second device fingerprint; and
completing the second login attempt on the second user device for the user account based on satisfying the confidence threshold.

10. A computer-implemented method comprising:
detecting, from a user device, a user authentication request for a session associated with a confidence threshold;
determining a confidence score for identifying a user account from a device fingerprint of the user device; and
authenticating, in response to the user authentication request, the user account on the user device for the session based on the confidence score satisfying the confidence threshold.

11. The computer-implemented method of claim 10, wherein authenticating the user device further comprises:
determining a device identifier derived from the device fingerprint;
identifying the user account associated with the device identifier in response to the confidence score satisfying the confidence threshold;
mapping a session token to the user account and the device identifier; and
authenticating the user device for the session using the session token.

12. The computer-implemented method of claim 11, wherein mapping the session token further comprises:
creating a new session token as the session token for the session; and
mapping the new session token to the user account and the device identifier.

13. The computer-implemented method of claim 11, wherein mapping the session token further comprises:
identifying a prior session token previously mapped to the user account and the device identifier; and
updating the prior session token as the session token.

14. The computer-implemented method of claim 11, wherein the mapping further includes mapping device metadata derived from the device fingerprint.

15. The computer-implemented method of claim 14, wherein the device metadata includes a type of device and a type of agent derived from the device fingerprint.

16. The computer-implemented method of claim 15, wherein the device identifier is unique for each combination of the type of device and the type of agent.

17. The computer-implemented method of claim 14, further comprising:
identifying, in response to identifying the user account, one or more active session tokens previously mapped to the user account;
identifying the device metadata associated with each of the one or more active session tokens; and
providing the user device a notification based on the identified device metadata.

18. The computer-implemented method of claim 17, further comprising:
receiving, from the user device in response to the notification, an update request for the one or more active session tokens; and
updating, in response to the update request, the one or more active session tokens.

19. The computer-implemented method of claim 10, further comprising:
prompting, for the user authentication request in response to failing to satisfy the confidence threshold, one or more authentication factors; and
authenticating the user device based on the one or more authentication factors.

20. The computer-implemented method of claim 10, wherein the user authentication request corresponds to a user action and the confidence threshold is based on an authentication strength associated with the user action.
